(19) United States
(12) Patent Application Publication
(10) Pub. No.: US 2012/0248358 A1
(43) Pub. Date: Oct. 4, 2012

(54) Magnet Assembly for a Solenoid Valve and Corresponding Solenoid Valve

(75) Inventors: Jean-Guillaume Pic, Levis (CA); Martin Haas, Oberstenfeld (DE); Wolfgang Mailaender, Hemmingen (DE)

(73) Assignee: ROBERT BOSCH GmbH, Stuttgart (DE)

(21) Appl. No.: 13/496,880

(22) PCT Filed: Jul. 21, 2010
(86) PCT No.: PCT/EP10/60563

§ 371 Date: Jun. 14, 2012

(51) Int. Cl. H01F 7/06; F16K 31/02

(52) U.S. Cl. 251/129.15; 335/296

(57) ABSTRACT

A magnet assembly for a solenoid valve, has a housing, which comprises a housing jacket as the ferromagnetic circuit upper part, a cover disc pressed into the housing jacket as the ferromagnetic circuit lower part, and a coil body, which is arranged inside the housing and comprises a winding carrier wound with a coil winding, wherein a tolerance-compensating mechanism is arranged on the coil body. A corresponding solenoid valve having such a magnet assembly is also disclosed. The tolerance-compensating mechanism is configured so that the winding carrier is pressed by a lower flange against the pressed-in cover disc in such a way that a boundary surface of the lower flange is seated substantially without gaps against a boundary surface of the cover disc, in order to form a thermal transition resistance that is as low as possible.

### PRIOR ART

The invention relates to a magnet assembly for a solenoid valve in accordance with the generic type of independent patent claim 1 and to an associated solenoid valve having a magnet assembly of this kind.

A conventional solenoid valve, in particular for a hydraulic unit which is used, for example, in an anti-lock brake system (ABS) or a traction control system (ASR system) or an electronic stability program system (ESP system), comprises a valve cartridge and a magnet assembly.

Laid-open specification DE 10 2006 047 921 A1 describes, as the prior art, a solenoid valve, in particular for a hydraulic unit, having a magnet assembly and a valve cartridge. The described conventional solenoid valve comprises the magnet assembly for generating a magnetic flux, which magnet assembly comprises a deep-drawn round housing jacket as the iron circuit upper part, a stamped covering disk as the iron circuit lower part and a winding support which is wound with a coil winding, and the valve cartridge which comprises a closing element, having a sealing element, and a valve seat. The coil winding which is wound onto the winding support forms an electrical coil, which can be actuated by means of electrical connections, and generates the magnetic flux in the iron circuit. The force for operating and/or controlling a fluid flow between an inlet opening and an outlet opening of the valve cartridge is adjusted by the closing element and the corresponding valve seat by supplying power to the coil winding via the electrical connections and the magnetic flux which is generated as a result. During production of the magnet assembly, the covering disk is pressed into the tubular housing jacket in order to connect the iron circuit upper part and the iron circuit lower part. The winding support is held in an axial position by spacer burls which are arranged on a lower flange. In addition, the spacer burls serve for tolerance compensation between the iron circuit, which is formed from the iron circuit upper part and the iron circuit lower part, and the winding support. Tolerance compensation is achieved by means of the compression of the spacer burls when the covering disk is pushed into the housing jacket. A differently sized air gap is left between the winding support and the covering disk depending on the tolerance. In addition, the spacer burls serve to fix and to orient the winding support when a winding process is performed on a winding mandrel (not illustrated).

### DISCLOSURE OF THE INVENTION

In comparison to the above, the magnet assembly according to the invention having the features of independent patent claim 1 has the advantage that tolerance-compensation means which are arranged on a coil former are designed such that a winding support is pushed against a covering disk, which is pressed into a housing jacket, by means of a lower flange such that a boundary surface of the lower flange rests substantially without a gap against a boundary surface of the covering disk in order to form a thermal contact resistance which is as low as possible. As a result, it is advantageously possible to place the winding support flat against the covering disk, so that heat can be dissipated from the coil winding, by means of the covering disk, to an adjoining hydraulic block or pump housing in an improved and therefore more uniform manner. On account of the improved heat dissipation, the magnet assembly can advantageously be connected for a longer period of time before the upper limit temperature of the coil former, in particular of the winding support material, is reached. In contrast to the magnet assembly of the conventional solenoid valve, there is now virtually no longer an air gap between the winding support and disk, while the external shape and the components of the magnet assembly are substantially maintained. This advantageously results firstly in a lower thermal contact resistance between the winding support and the covering disk and therefore effective heat dissipation from the coil winding to the surrounding area, that is to say to the hydraulic block or pump housing, and secondly the scatter of the thermal contact resistance is advantageously also reduced. The lower thermal contact resistance allows power to be supplied to the coil winding for a longer period of time and/or at a higher power. The reduced scatter of the thermal contact resistance allows more accurate predictions to be made for the expected temperature profile and the maximum temperature when coil temperature models are used.

The magnet assembly according to the invention can be used for any solenoid valves in the vehicle on account of its substantially unchanged external shape. The solenoid valve according to the invention can be used, for example, in fluid assemblies which are used in an anti-lock brake system (ABS) or a traction control system (ASR system) or an electronic stability program system (ESP system).

Advantageous improvements to the magnet assembly which is specified in independent patent claim 1 are possible by virtue of the measures and developments discussed in the dependent claims.

It is particularly advantageous for the tolerance-compensation means to be designed as at least one spacer burl which is arranged between an upper flange of the winding support and the housing jacket. This results in a particularly simple embodiment which advantageously does not require any substantial changes to the housing jacket of the magnet assembly. In this embodiment, the at least one spacer burl is deformed after the covering disk is pressed into the housing jacket, as a result of which the coil former is fixed between the housing jacket and the covering disk, with the coil former resting substantially without a gap on the covering disk.

In a refinement of the magnet assembly according to the invention, the tolerance-compensation means are designed as at least one lug which is integrally formed as a lateral step on the lower flange of the winding support. This embodiment of the tolerance-compensation means advantageously also ensures that the coil former rests substantially without a gap on the covering disk. In this case, the at least one lug rests against a corresponding cutout in the housing jacket after the covering disk is pressed into the housing jacket, with tolerance compensation being performed by virtue of the elasticity of the at least one lug. This means that the at least one lug which rests against the corresponding cutout in the housing jacket is advantageously tensioned, and therefore the coil former is pushed onto the covering disk.

Advantageous embodiments of the invention which will be described below and the conventional exemplary embodiment which has been explained above for better understanding of the embodiments are illustrated in the drawings. In the drawings, identical reference symbols denote elements and components which execute the same or similar functions.

### BRIEF DESCRIPTION OF THE DRAWINGS

FIG. 1 shows a schematic sectional illustration of a first exemplary embodiment of a magnet assembly according to the invention.

FIG. 2 shows a schematic sectional illustration of a second exemplary embodiment of a magnet assembly according to the invention.

### EMBODIMENTS OF THE INVENTION

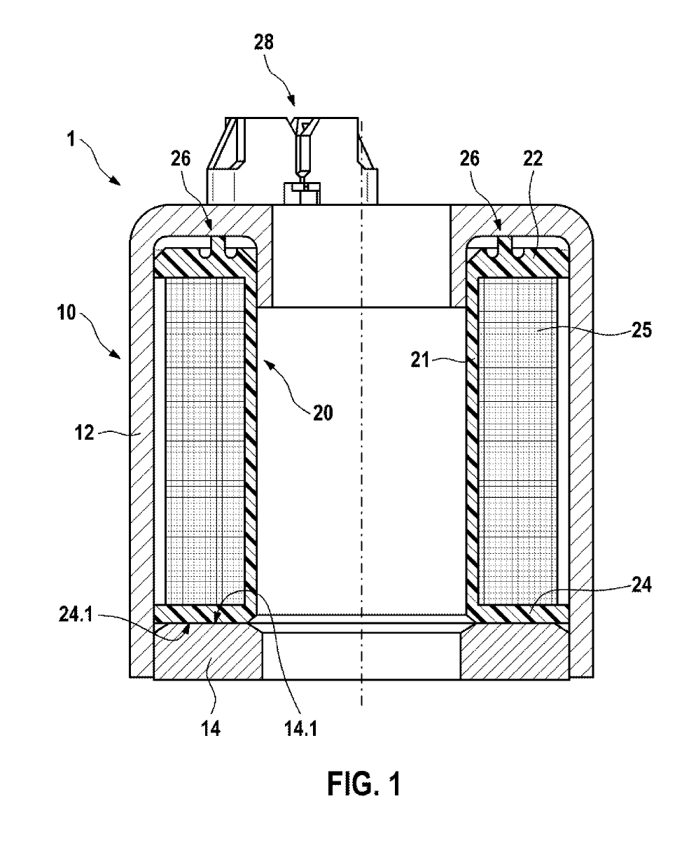

As shown in FIG. 1, a first exemplary embodiment of a magnet assembly 1 according to the invention for a solenoid valve comprises a housing 10 which comprises a housing jacket 12 as the iron circuit upper part and a covering disk 14, which is pressed into the housing jacket 12, as the iron circuit lower part, and a coil former 20 which is arranged inside the housing 10 and comprises a winding support 21 which is wound with a coil winding 25 and has an upper flange 22 and a lower flange 24. Analogously to the prior art, the coil winding 25 which is wound onto the winding support 21 forms an electrical coil which can be actuated by means of electrical connections 28 and generates the magnetic flux in the iron circuit. In addition, tolerance-compensation means 26 are arranged on the coil former 20, said tolerance-compensation means being designed, according to the invention, such that the winding support 21 is pushed against the pressed-in covering disk 14 by means of the lower flange 24 such that a boundary surface 24.1 of the lower flange 24 rests substantially without a gap against a boundary surface 14.1 of the covering disk 14 in order to form a thermal contact resistance which is as low as possible. In the illustrated first exemplary embodiment, the tolerance-compensation means are designed as spacer burls 26 which are arranged between the upper flange 22 and the housing jacket 12 and, as a result, make it possible for the coil former 20 to rest substantially without a gap on the covering disk 14.

As also shown in FIG. 1, the spacer burls are deformed after the covering disk is pressed into the housing jacket 12, and said spacer burls fix the coil former 20 between the housing jacket 12 and the covering disk 14. The spacer burls 26 at the top can be used to place the winding support 21, by way of its lower flange 24, flat against the covering disk 14, so that heat can be dissipated from the coil winding 25, by means of the covering disk 14, to the adjoining hydraulic block or pump housing (not illustrated) in an improved and therefore more uniform manner. On account of the improved heat dissipation, the magnet group 1 according to the invention can be connected for a longer period of time before the upper limit temperature of the coil winding 25, in particular of the winding support material, is reached.

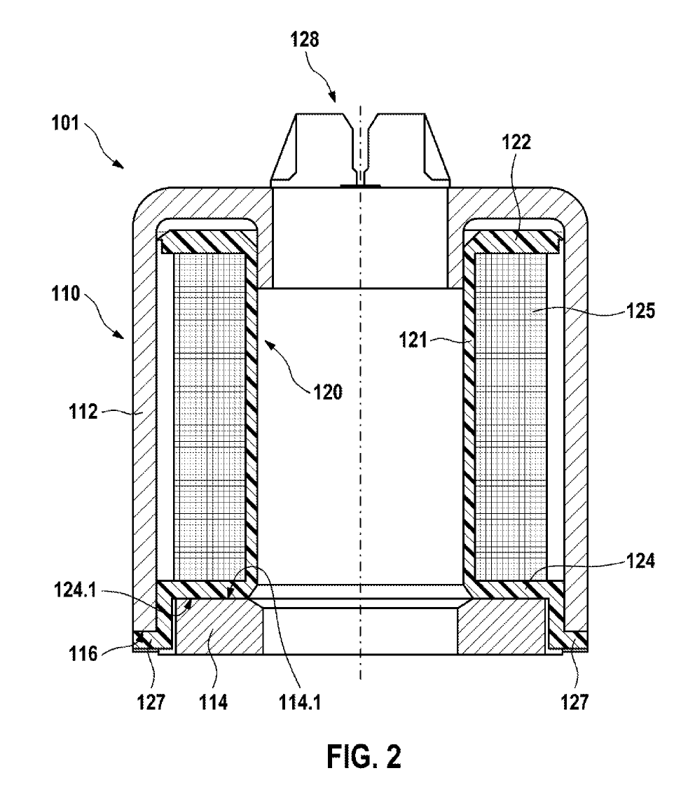

As shown in FIG. 2, a second exemplary embodiment of a magnet assembly 101 according to the invention for a solenoid valve comprises, analogously to the first exemplary embodiment, a housing 110 which comprises a housing jacket 112 as the iron circuit upper part and a covering disk 114, which is pressed into the housing jacket 112, as the iron circuit lower part, and a coil former 120 which is arranged inside the housing 110 and comprises a winding support 121 which is wound with a coil winding 125 and has an upper flange 122 and a lower flange 124. Analogously to the prior art, the coil winding 125 which is wound onto the winding support 121 forms an electrical coil which can be actuated by means of electrical connections 128 and generates the magnetic flux in the iron circuit. In addition, tolerance-compensation means 127 are arranged on the coil former 120, said tolerance-compensation means being designed, according to the invention, such that the winding support 121 is pushed against the pressed-in covering disk 114 by means of the lower flange 124 such that a boundary surface 124.1 of the lower flange 124 rests substantially without a gap against a boundary surface 114.1 of the covering disk 114 in order to form a thermal contact resistance which is as low as possible. In the illustrated second exemplary embodiment, the tolerance-compensation means are designed as lugs 127 which are integrally formed as lateral steps on the lower flange 124 of the winding support 121 and in each case rest against a cutout 116 in the housing jacket 112 after the covering disk 114 is pressed into the housing jacket 112. In the case of the design in the form of lugs 127, tolerance compensation is performed by virtue of the elasticity of the at least one lug 127, with the lugs 127 which rest against cutouts 116 in the housing jacket 112 being tensioned such that the coil former 120 is pushed substantially without a gap onto the covering disk 114.

On account of the lugs 127, it is possible to place the winding support 121, by way of its lower flange 124, flat against the covering disk 14, so that heat can be dissipated from the coil winding 125, by means of the covering disk 114, to the adjoining hydraulic block or pump housing (not illustrated) in an improved and therefore more uniform manner. On account of the improved heat dissipation, the magnet group 101 according to the invention can be connected for a longer period of time before the upper limit temperature of the coil former 25, in particular of the winding support material, is reached.

The magnet assembly 1, 101 according to the invention generates the required magnetic flux in order to adjust a fluid flow between at least one inlet opening and at least one outlet opening in the solenoid valve by means of at least one corresponding closing body and at least one valve seat and can be used in any desired solenoid valves.

Embodiments of the present invention advantageously make it possible for there to virtually no longer be an air gap between the winding support and disk. This results in a lower thermal contact resistance between the winding support and the surrounding area, that is to say the hydraulic block or pump housing. In addition, the scatter of the thermal contact resistance between the produced magnet assemblies can also be reduced. The lower contact resistance allows power to be supplied to the coil for a longer period of time and/or at a higher power, and the reduced scatter allows more accurate predictions to be made for the expected temperature profile and the maximum temperature within the magnet assembly, for example, when coil temperature models are used.

1. A magnet assembly for a solenoid valve, comprising:
a housing having (i) a housing jacket forming an iron circuit upper part, and (ii) a covering disk which is pressed into the housing jacket forming an iron circuit lower part, said covering disk defining a first boundary surface, and
a coil former which is arranged inside the housing, the coil former including (i) a winding support having a lower flange defining a second boundary surface, and (ii) a coil winding wound around the winding support, and
a tolerance-compensation mechanism arranged on the coil former the tolerance-compensation mechanism being configured such that the winding support is pushed against the covering disk by the lower flange such that the second boundary surface of the lower flange rests substantially without a gap against the first boundary surface of the covering disk in order to form a thermal contact resistance which is as low as possible.

2. The magnet assembly as claimed in claim 1, wherein:
the covering disk further includes an upper flange, and
the tolerance-compensation mechanism is designed as at least one spacer burl which is arranged between the upper flange of the winding support and the housing jacket.

3. The magnet assembly as claimed in claim 2, wherein the at least one spacer burl is configured to be deformed after the covering disk is pressed into the housing jacket, and said spacer burl is configured to fix the coil former between the housing jacket and the covering disk.

4. The magnet assembly as claimed in claim 1, wherein the tolerance-compensation mechanism is designed as at least one lug which is integrally formed as a lateral step on the lower flange of the winding support.

5. The magnet assembly as claimed in claim 4, wherein:
the housing jacket includes a housing cutout surface that defines a cutout, and
the at least one lug rests against the housing cutout surface after the covering disk is pressed into the housing jacket, with tolerance compensation being performed by virtue of elasticity of the at least one lug.

6. The magnet assembly as claimed in claim 5, wherein the at least one lug is configured to be tensioned so that the coil former is pushed onto the covering disk.

7. A solenoid valve including a magnet assembly, comprising:
a housing having (i) a housing jacket forming an iron circuit upper part, and (ii) a covering disk which is pressed into the housing jacket forming an iron circuit lower part, said covering disk defining a first boundary surface, and
a coil former which is arranged inside the housing, the coil former including (i) a winding support having a lower flange defining a second boundary surface, and (ii) a coil winding wound around the winding support, and
a tolerance-compensation mechanism arranged on the coil and configured such that the winding support is pushed against the covering disk by the lower flange such that the second boundary surface of the lower flange rests substantially without a gap against the first boundary surface of the covering disk in order to form a thermal contact resistance.
